(19) United States
(12) Patent Application Publication
(10) Pub. No.: US 2018/0205269 A1
(43) Pub. Date: Jul. 19, 2018

(54) FOREIGN OBJECT DETECTING CIRCUIT AND WIRELESS POWER TRANSMISSION DEVICE USING THE SAME

(71) Applicant: Samsung Electro-Mechanics Co., Ltd., Suwon-si (KR)

(72) Inventors: Dong Woo HAN, Suwon-si (KR); Byoung Woo RYU, Suwon-si (KR); Young Seung ROH, Suwon-si (KR); Se Joo KIM, Suwon-si (KR)

(73) Assignee: Samsung Electro-Mechanics Co., Ltd., Suwon-si (KR)

(21) Appl. No.: 15/802,918

(22) Filed: Nov. 3, 2017

(30) Foreign Application Priority Data
Jan. 13, 2017 (KR) 10-2017-0006346

(51) Int. Cl. H02J 50/60; H02J 50/90; H02M 7/02

(52) U.S. Cl. CPC H02J 50/60; H02J 50/80; H02M 7/02; H02J 50/90

(57) ABSTRACT

A wireless power transmission device includes a power amplifier, a detection device, and a control unit. The power amplifier is configured to receive a direct current (DC) voltage and supply an alternating current (AC) power current to a transmission resonator by performing a switching operation. The detection device is configured to detect a voltage of an output terminal of the power amplifier based on the switching operation. The control unit is configured to detect an external object based on a change in the voltage, and control an output of the power amplifier in response to the change.

### CROSS-REFERENCE TO RELATED APPLICATION

This application claims the benefit under 35 USC 119(a) of Korean Patent Application No. 10-2017-0006346, filed on Jan. 13, 2017 in the Korean Intellectual Property Office, the entire disclosure of which is incorporated herein by reference for all purposes.

### BACKGROUND

### 1. Field

The following description relates to a foreign object detecting circuit and to a wireless power transmission device using the same.

### 2. Description of Related Art

In accordance with the development of wireless technology, various wireless functions, ranging from the transmission of data to the transmission of power, have been enabled. Particularly, wireless power transmission technology allowing electronic devices to be charged with power, even in a non-contact state between an electronic device and a wireless power transmission device, has recently been developed.

Since such wireless power transmission technology forms a strong magnetic field, it is critical to detect whether foreign objects are present within a magnetic field thereof.

A foreign object detecting technology of the related art is suggested by a wireless charging standard that detects the presence of foreign objects based on an amount of impedance change in a transmission resonator before devices are wirelessly charged.

However, in the case of foreign object detecting technology of the related art, foreign objects such as an integrated circuit (IC) card and a coin may not be detected due to the insignificant amount of impedance change.

### SUMMARY

This Summary is provided to introduce a selection of concepts that are further described below in the Detailed Description in simplified form. This Summary is not intended to identify key features or essential features of the claimed subject matter, nor is it intended to be used as an aid in determining the scope of the claimed subject matter.

In one general aspect, a wireless power transmission device includes a power amplifier, a detection device, and a control unit. The power amplifier is configured to receive a direct current (DC) voltage and supply an alternating current (AC) power current to a transmission resonator by performing a switching operation. The detection device is configured to detect a voltage of an output terminal of the power amplifier based on the switching operation. The control unit is configured to detect an external object based on a change in the voltage, and control an output of the power amplifier in response to the change.

The change in the voltage may be between an anode output terminal and a cathode output terminal of the output terminal of the power amplifier.

The control unit may detect a change in a peak voltage of the output terminal and control the output of the power amplifier when the change in the peak voltage occurs.

In a normal state, the control unit may control at least one switch comprised in the power amplifier using a zero voltage switching (ZVS) method.

The power amplifier may include a first amplifier switch having one end connected to the anode output terminal and another end connected to a ground terminal; and a second amplifier switch having one end connected to the cathode output terminal and another end connected to the ground terminal.

The control unit may compare a stored range of voltages of the output of the power amplifier in the normal state to a current voltage of the output of the power amplifier, and stop the output of the power amplifier when the current voltage is detected to be outside of the stored range of the voltages.

When the current voltage is outside of the stored range of voltages in the normal state, the control unit may be configured to determine whether the external object disposed adjacent to a wireless power transmission device is a wireless power reception device.

The detection device may include a first detection circuit connected to the ground terminal and the anode output terminal to detect an output of the anode output terminal; and a second detection circuit connected to the ground terminal and the cathode output terminal to detect an output of the cathode output terminal.

The first detection circuit may further comprise a voltage divider circuit including a plurality of resistors connected in series.

In another general aspect, a foreign object detecting circuit, applied to a wireless power transmission device, includes a power amplifier and a detection device. The power amplifier is configured to receive a DC voltage and generate an AC power current by performing a switching operation of a pair of switches connected in parallel. The detection device is configured to detect a voltage between an anode output terminal and a cathode output terminal of an output terminal of the power amplifier.

The power amplifier may include a first inductor and a second inductor, each having an end connected to an input terminal; a first amplifier switch having one end connected to the anode output terminal and another end of the first inductor, and the other end connected to a ground terminal; and a second amplifier switch having one end connected to the cathode output terminal and another end of the second inductor, and the other end connected to the ground terminal.

The first amplifier switch and the second amplifier may be configured to switch alternately in a switching operation.

The detection device may include a first detection circuit connected to the anode output terminal and the ground terminal to detect an output of the anode output terminal; and a second detection circuit connected to the cathode output terminal and the ground terminal to detect an output of the cathode output terminal.

The first detection circuit may further include a voltage divider circuit having a plurality of resistors connected in series.

The power amplifier may be operated using a zero voltage switching (ZVS) method in a normal state.

The foreign object detecting circuit may be configured to determine that a foreign object is detected, when a voltage between the anode output terminal and the cathode output terminal of the output terminal is detected to be outside of a range of voltages between the anode output terminal and the cathode output terminal of the output terminal of the power amplifier in the normal state.

In another general aspect, a wireless power transmission device includes a power amplifier, a detection device, and a control unit. The power amplifier includes switches connected to an input terminal to supply an alternating current (AC) power current to a transmission resonator. The detection device is configured to detect a voltage between an anode input terminal and a cathode input terminal of each of the switches. The control unit is configured to detect an external object based on a voltage change between an anode output terminal and a cathode output terminal of an output terminal of the power amplifier, and control an output of the power amplifier in response to the voltage change.

The control unit may compare a stored range of voltages of the output of the power amplifier in the normal state to a current voltage of the output of the power amplifier, and stop the output of the power amplifier when the current voltage is detected to be outside of the stored range of the voltages.

The control unit may detect a change in a peak voltage of the output terminal.

In a normal state, the control unit may control at least one of the switches using a zero voltage switching (ZVS) method.

Other features and aspects will be apparent from the following detailed description, the drawings, and the claims.

### BRIEF DESCRIPTION OF THE DRAWINGS

FIG. 1 is a view illustrating an example of a wireless power transmission device.

FIG. 2 is a block diagram illustrating an example of a wireless power transmission device.

FIG. 3 is a circuit diagram illustrating an example of a foreign object detecting circuit.

FIG. 4 is a graph illustrating an output voltage of a power amplifier in a normal state, illustrated in FIG. 3.

FIG. 5 is a graph illustrating an output voltage of the power amplifier, illustrated in FIG. 3, in a state in which a foreign object is present.

FIG. 6 is a graph illustrating an output voltage of the power amplifier, illustrated in FIG. 3, during a specific period.

Throughout the drawings and the detailed description, the same reference numerals refer to the same elements. The drawings may not be to scale, and the relative sizes, proportions, and depictions of elements in the drawings may be exaggerated for the purpose of clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

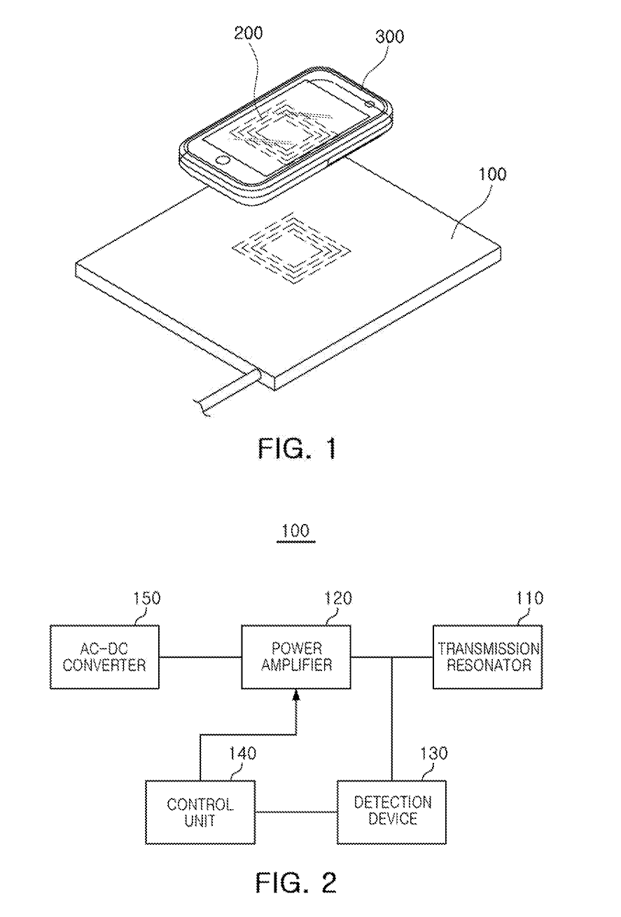

FIG. 1 is a view illustrating an example of a wireless power transmission device.

With reference to FIG. 1, a wireless power reception device 200 is adjacently disposed to a wireless power transmission device 100, and is magnetically coupled to the wireless power transmission device 100 (e.g., by magnetic resonance or magnetic induction) to wirelessly receive power.

The wireless power reception device 200 supplies the received power to an electronic device 300. The wireless power reception device 200 is depicted as a single component present in the electronic device 300 or may be a separate device connected to the electronic device 300.

A foreign object may be present on a periphery of the wireless power transmission device 100, although the foreign object is not illustrated in FIG. 1.

Certain types of foreign objects that change the impedance of a transmission resonator in the wireless power transmission device 100, such as the electronic device 300 not to be charged, are detected. However, there are also other types of foreign objects, such as a coin and a near field communication (NFC) card, that are hard to detect using a change in impedance due to an insignificant effect on the transmission resonator.

Thus, the wireless power transmission device 100 detects a voltage between an anode input terminal and a cathode input terminal of a switch of a power amplifier. The wireless power transmission device 100 determines when a foreign object is present based on a change in the voltage between an anode input terminal and a cathode input terminal of the switch.

Hereinafter, with reference to FIG. 2, a wireless power transmission device is described in more detail.

FIG. 2 is a block diagram illustrating a wireless power transmission device according to an example.

With reference to FIG. 2, a wireless power transmission device 100 includes a power amplifier 120, a detection device 130, and a control unit 140.

The wireless power transmission device 100 further includes a transmission resonator 110 and/or an alternating current to direct current (AC-DC) converter 150.

The AC-DC converter 150 receives commercial AC power and converts the commercial AC power into a DC voltage to be used in the power amplifier 120.

In detail, the AC-DC converter 150 is provided as a power adapter. According to an example, the AC-DC converter 150 is implemented as a single component of the wireless power transmission device 100 but may also be implemented as a separate device connected to the wireless power transmission device 100.

The power amplifier 120 receives a DC voltage and supplies an AC power current to the transmission resonator 110. The power amplifier 120 includes at least one power amplifying element. The power amplifier 120 adjusts a magnitude of a voltage or a current, supplied to the transmission resonator 110 by controlling switching of the power amplifying element.

The power amplifier 120 outputs a voltage between an anode input terminal and a cathode input terminal, that is, a voltage between an anode input terminal and a cathode input terminal of a switch of the power amplifier 120. The voltage between an anode input terminal and a cathode input terminal are connected to opposing ends of the transmission resonator 110, respectively.

The power amplifier 120 generates a potential difference between the opposing ends of the transmission resonator 110 to allow a coil current to flow in the transmission resonator 110, so that the transmission resonator 110 is magnetically coupled to a reception resonator (not illustrated) of an external wireless power reception device.

A matching circuit is further provided between the transmission resonator 110 and the power amplifier 120, although the matching circuit is not illustrated.

The detection device 130 detects an output voltage of the power amplifier 120.

In one example, the detection device 130 detects a voltage between an anode input terminal and a cathode input terminal of an output terminal of the power amplifier 120.

The detection device 130 may detect an output voltage of an anode input terminal and an output voltage of a cathode input terminal of the power amplifier 120, separately.

The control unit 140 detects the presence of a foreign object based on a change in the voltage between an anode input terminal and a cathode input terminal of an output terminal of the power amplifier 120, detected by the detection device 130, and controls an output of the power amplifier 120 in response thereto.

In a case in which a relatively small foreign object, such as a coin or an NFC card, is disposed on the wireless power transmission device 100, the change in impedance may be relatively insignificant such that it is difficult to recognize the presence of a foreign object. However, a change in a voltage applied to opposing ends of a switch of the power amplifier 120, caused by even the relatively small foreign object such as a coin or an NFC card, is relatively significant enough to discern.

The control unit 140 includes at least one processing unit and may further include a memory. In detail, the processing unit may include a central processing unit (CPU), a graphics processing unit (GPU), a microprocessor, an application specific integrated circuit (ASIC), a field programmable gate array (FPGA), and the like, and may include a plurality of cores. The memory may be provided as a volatile memory (e.g., a random access memory (RAM), or the like), a non-volatile memory (e.g., a read only memory (ROM), a flash memory, or the like), or combinations thereof.

In an example, the wireless power transmission device 100 is set such that a peak-to-peak voltage of opposing ends of the switch of the power amplifier 120 in a power transmission mode is a predetermined multiple of an input voltage of the power amplifier 120. For example, the peak-to-peak voltage may be 3.56 times the input voltage of the power amplifier 120, which is to satisfy ideal zero voltage switching (ZVS).

To this end, a parallel capacitor of the switch of the power amplifier 120, or the inductance or capacitance of a filter applied to the power amplifier 120 is adjusted to satisfy ZVS conditions.

When the ZVS conditions of the power amplifier 120 are satisfied and a foreign object is disposed on the wireless power transmission device 100, the impedance value of a transmission coil of the transmission resonant 110 changes. When the ZVS conditions are not satisfied and the change in the impedance value is insignificant, it is difficult to detect the foreign object using only the change. But when there's a change in impedance and the ZVS conditions of the wireless power transmission device 100 are satisfied, the voltage between an anode input terminal and a cathode input terminal of the power amplifier 120 significantly changes.

As a result, even when there's an insignificant amount of impedance change, the changes in voltage between an anode input terminal and a cathode input terminal of the power amplifier 120 becomes sufficiently significant to detect the foreign object. Thus, the control unit 140 is configured to detect a foreign object using the impedance change.

In an example, the control unit 140 detects a change in an output voltage of an anode output terminal and a cathode output terminal of the switch of the power amplifier 120, separately. The control unit 140 determines that a foreign object is present when both the output voltage of the cathode output terminal and the anode output terminal change. Since both output terminals are electrically connected to opposing ends of the transmission resonator 110, respectively, when only one voltage of two output voltages changes, there's a greater possibility of the voltage change occurring due to internal processing of the detection device 130 or the control unit 140, rather than the voltage change occurring due to an external object.

In an example, the control unit 140 detects a foreign object using an output peak value of the power amplifier 120. In other words, the control unit 140 detect a change in a peak voltage of the output terminal of the power amplifier 120. When the change in the peak voltage occurs, the control unit 140 determines that a foreign object is present and controls the output of the power amplifier 120.

As described above, the control unit 140 in a normal state controls a switch, included in the power amplifier 120, using a ZVS method. Since, in the case of the ZVS method, switching is performed in a state in which a voltage is 0, switching losses are minimized. In a case in which the switch is controlled based on ZVS, switching losses generated by even a small change in impedance causes a change in the output voltage of the power amplifier 120.

In an example, the control unit 140 stores a range of voltages that occur between an anode input terminal and a cathode input terminal of the output terminal of the power amplifier 120 in a normal state. In a case in which the voltage between the anode input terminal and the cathode input terminal of the output terminal of the power amplifier 120 is detected to be outside of the range of the stored voltages in a normal state, the control unit 140 stops an output of the power amplifier 120. In other words, the control unit 140 determines that a foreign object is present when the output voltage of the power amplifier 120 is outside of a normal range. In addition, in a case in which the case described above occurs in the power transmission mode, the control unit 140 immediately stops power transmission to prevent damage to the foreign object, which may be a NFC or another circuitry.

If the power transmission is not stopped in a power transmission mode when a foreign object is detected and the object is a NFC card, the NFC card may be exposed to damaging power input. Thus, when a foreign object is detected, the control unit 140 immediately stops power transmission.

In an example, when a voltage between an anode input terminal and a cathode input terminal of the output terminal of the power amplifier 120 is detected to be outside of the range of voltage of the power amplifier 120 in a normal state, the control unit 140 determines whether an external object disposed to be adjacent to the wireless power transmission device 100 is a wireless power reception device. In other words, when a foreign object is detected, the control unit 140 determines whether the foreign object is the wireless power reception device. In a case in which the foreign object is the wireless power reception device, the control unit 140 performs a controlling function, such as resumption of wireless power transmission or transmission of power to another wireless power reception device.

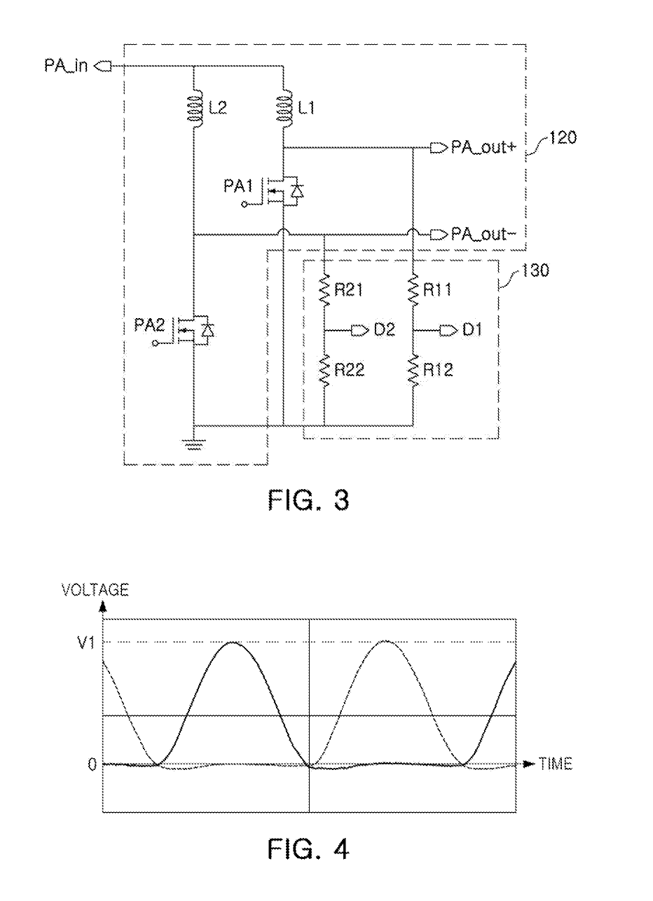

FIG. 3 is a circuit diagram illustrating an example of a foreign object detecting circuit.

With reference to FIG. 3, the foreign object detecting circuit includes a power amplifier 120 and a detection device 130. The foreign object detecting circuit corresponds to the power amplifier 120 and the detection device 130 of the wireless power transmission device of FIG. 2.

The power amplifier 120 includes a first inductor L1, a second inductor L2, a first amplifier switch PA1, and a second amplifier switch PA2.

A first end of the first inductor L1 is connected to an input terminal PA_in, while a second end thereof is connected to a first end of the first amplifier switch PA1 and an anode output terminal PA_out+.

A first end of the second inductor L2 is connected to an input terminal PA_in, while a second end thereof is connected to a first end of the second amplifier switch PA2 and a cathode output terminal PA_out−.

A first end of the first amplifier switch PA1 is connected to an anode output terminal PA_out+ and the second end of the first inductor L1, while a second end thereof is connected to a ground terminal.

A first end of the second amplifier switch PA2 is connected to the cathode output terminal PA_out− and the second end of the second inductor L2, while a second end thereof is connected to the ground terminal.

Thus, the first amplifier switch PA1 and the second amplifier switch PA2 are connected between the input terminal PA_in and the ground terminal in parallel.

The first amplifier switch PA1 and the second amplifier switch PA2 may alternately perform a switching operation. Current accumulated in the first inductor L1 and the second inductor L2 are supplied to the anode output terminal PA_out+ and the cathode output terminal PA_out− by performing the switching operation, respectively, thereby generating AC output.

The detection device 130 includes a first detection circuit and a second detection circuit.

The first detection circuit is connected to the anode output terminal PA_out+ and the ground terminal to detect the output of the anode output terminal PA_out+.

The second detection circuit is connected to the cathode output terminal PA_out− and the ground terminal to detect the output of the cathode output terminal PA_out−.

According to an example, the detection device 130 may include a voltage divider circuit.

In the illustrated example, it can be confirmed that, in a first detection circuit, a fraction of the output of the anode output terminal PA_out+ is output at D1 due to resistors R11 and R12 connected in series. It is further confirmed that, in a second detection circuit, a fraction of the output of the cathode output terminal PA_out− is output at D2 due to resistors R21 and R22 connected in series.

In a case in which the voltage between the anode input terminal and the cathode input terminal of the output terminal of the power amplifier 120, detected by the detection device 130, is outside of a range of a normal state, it can be determined that a foreign object has been detected, as described above.

FIG. 4 is a graph illustrating an output voltage of a power amplifier in a normal state, illustrated in FIG. 3.

In the illustrated example, a solid line illustrates an output voltage of an anode output terminal, while a dashed line illustrates an output voltage of a cathode output voltage.

The graph illustrated in FIG. 4 depicts a case in which an anode output voltage and a cathode output voltage alternately output an AC voltage lower than or equal to a maximum voltage value V1 in a normal state in which a foreign object is not present.

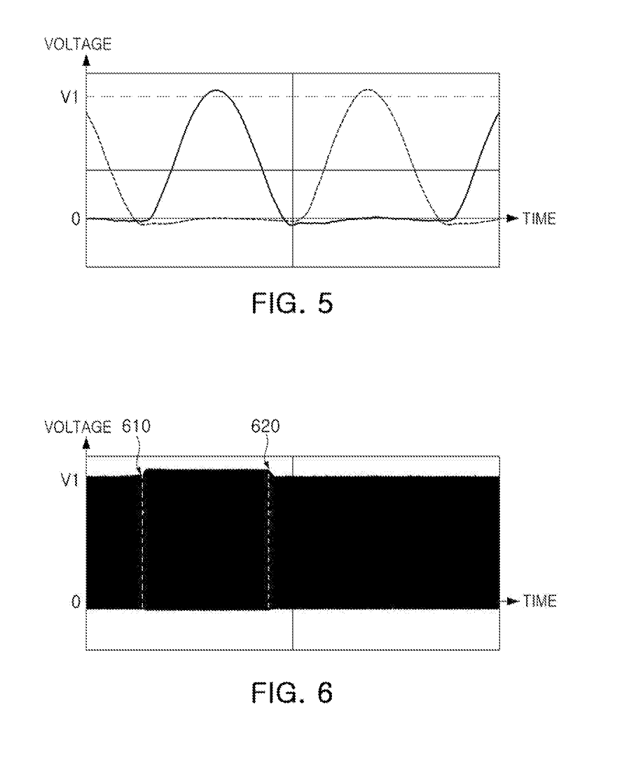

FIG. 5 is a graph illustrating an output voltage of the power amplifier, illustrated in FIG. 3, in a state in which a foreign object is present.

In the illustrated example, a solid line illustrates an output voltage of an anode output terminal, while a dashed line illustrates an output voltage of a cathode output voltage.

In an example illustrated in FIG. 5, it can be confirmed that the anode output voltage and the cathode output voltage exceed the voltage range in a normal state, for example, a maximum voltage value V1. It can also be confirmed that an anode peak value of a voltage is higher than the maximum voltage value V1, and a minimum voltage is maintained at a value lower than or equal to 0 for a specific period of time.

Thus, a control unit detects the presence of a foreign object based on the change in a voltage.

FIG. 6 is a graph illustrating an output voltage of the power amplifier, illustrated in FIG. 3, during a specific period.

The graph illustrated in FIG. 6 is illustrated by extending the data collection time of graphs illustrated in FIGS. 4 to 5. In other words, a plot line of the graph is extended by increasing a time of 1 division in an oscilloscope.

In the illustrated example, output of a power amplifier is stably performed in a range of a minimum value 0 V to a maximum value V 1 V before identification number 610.

It can be confirmed that, in a section between identification number 610 and identification number 620, output of the power amplifier is a peak value higher than the maximum value V 1 in a normal state.

Thus, it can be confirmed that the section between identification number 610 and identification number 620 corresponds to a section in which a foreign object is present.

It can be confirmed that in a section after identification number 620, the foreign object has been removed, since output of the power amplifier is between the range of the minimum value 0 V to the maximum value V 1 V.

As set forth above, according to examples, a wireless power transmission device detects even a relatively small foreign object, such as a small coin that induces a relatively insignificant amount of impedance change.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit were to be combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless power transmission device, comprising:
a power amplifier configured to receive a direct current (DC) voltage and supply an alternating current (AC) power current to a transmission resonator by performing a switching operation;
a detection device configured to detect a voltage of an output terminal of the power amplifier based on the switching operation; and
a control unit configured to detect an external object based on a change in the voltage, and control an output of the power amplifier in response to the change.

2. The wireless power transmission device of claim 1, wherein the change in the voltage is between an anode output terminal and a cathode output terminal of the output terminal of the power amplifier.

3. The wireless power transmission device of claim 1, wherein the control unit detects a change in a peak voltage of the output terminal and controls the output of the power amplifier when the change in the peak voltage occurs.

4. The wireless power transmission device of claim 1, wherein, in a normal state, the control unit controls at least one switch comprised in the power amplifier using a zero voltage switching (ZVS) method.

5. The wireless power transmission device of claim 2, wherein the power amplifier comprises:
a first amplifier switch having one end connected to the anode output terminal and another end connected to a ground terminal; and
a second amplifier switch having one end connected to the cathode output terminal and another end connected to the ground terminal.

6. The wireless power transmission device of claim 4, wherein the control unit compares a stored range of voltages of the output of the power amplifier in the normal state to a current voltage of the output of the power amplifier, and stops the output of the power amplifier when the current voltage is detected to be outside of the stored range of the voltages.

7. The wireless power transmission device of claim 6, wherein, when the current voltage is outside of the stored range of voltages in the normal state, the control unit is configured to determine whether the external object disposed adjacent to a wireless power transmission device is a wireless power reception device.

8. The wireless power transmission device of claim 5, wherein the detection device comprises:
a first detection circuit connected to the ground terminal and the anode output terminal to detect an output of the anode output terminal; and
a second detection circuit connected to the ground terminal and the cathode output terminal to detect an output of the cathode output terminal.

9. The wireless power transmission device of claim 8, wherein the first detection circuit further comprises a voltage divider circuit including a plurality of resistors connected in series.

10. A foreign object detecting circuit, applied to a wireless power transmission device, comprising:
a power amplifier configured to receive a DC voltage and generate an AC power current by performing a switching operation of a pair of switches connected in parallel; and
a detection device configured to detect a voltage between an anode output terminal and a cathode output terminal of an output terminal of the power amplifier.

11. The foreign object detecting circuit of claim 10, wherein the power amplifier comprises:
a first inductor and a second inductor, each having an end connected to an input terminal;
a first amplifier switch having one end connected to the anode output terminal and another end of the first inductor, and the other end connected to a ground terminal; and
a second amplifier switch having one end connected to the cathode output terminal and another end of the second inductor, and the other end connected to the ground terminal.

12. The foreign object detecting circuit of claim 11, wherein the first amplifier switch and the second amplifier are configured to switch alternately in a switching operation.

13. The foreign object detecting circuit of claim 11, wherein the detection device comprises:
a first detection circuit connected to the anode output terminal and the ground terminal to detect an output of the anode output terminal; and
a second detection circuit connected to the cathode output terminal and the ground terminal to detect an output of the cathode output terminal.

14. The foreign object detecting circuit of claim 13, wherein the first detection circuit further comprises a voltage divider circuit having a plurality of resistors connected in series.

15. The foreign object detecting circuit of claim 10, wherein the power amplifier is operated using a zero voltage switching (ZVS) method in a normal state.

16. The foreign object detecting circuit of claim 15, wherein the foreign object detecting circuit is configured to:
determines that a foreign object is detected, when a voltage between the anode output terminal and the cathode output terminal of the output terminal is detected to be outside of a range of voltages between the anode output terminal and the cathode output terminal of the output terminal of the power amplifier in the normal state.

17. A wireless power transmission device, comprising:
a power amplifier comprising switches connected to an input terminal to supply an alternating current (AC) power current to a transmission resonator;
a detection device configured to detect a voltage between an anode input terminal and a cathode input terminal of each of the switches; and
a control unit configured to detect an external object based on a voltage change between an anode output terminal and a cathode output terminal of an output terminal of the power amplifier, and control an output of the power amplifier in response to the voltage change.

18. The wireless power transmission device of claim 17, wherein the control unit compares a stored range of voltages of the output of the power amplifier in the normal state to a current voltage of the output of the power amplifier, and stops the output of the power amplifier when the current voltage is detected to be outside of the stored range of the voltages.

19. The wireless power transmission device of claim 17, wherein the control unit detects a change in a peak voltage of the output terminal.

20. The wireless power transmission device of claim 19, wherein, in a normal state, the control unit controls at least one of the switches using a zero voltage switching (ZVS) method.
